(19) United States
(12) Patent Application Publication
(10) Pub. No.: US 2007/0026327 A1
(43) Pub. Date: Feb. 1, 2007

(54) Electrophotographic photoreceptor for preventing image deterioration from repeated use and electrophotographic image forming apparatus employing the photoreceptor

(75) Inventors: An-kee Lim, Gunpo-si (KR); Saburo Yokota, Suwon-si (KR); Kyung-yol Yon, Seongnam-si (KR); Moto Makino, Suwon-si (KR); Sung-ho Kang, Seongnam-si (KR); Seung-ju Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/494,509

(22) Filed: Jul. 28, 2006

(30) Foreign Application Priority Data
Jul. 28, 2005 (KR) 10-2005-0069117

(51) Int. Cl. G03G 5/047

(52) U.S. Cl. 430/58.4; 430/59.5; 430/65; 430/59.6; 430/58.8; 430/58.85; 399/159

(57) ABSTRACT

An electrophotographic photoreceptor is provided that includes an underlayer, a charge generating layer, and a charge transporting layer that are sequentially formed on an electrically conductive substrate. The underlayer includes a metal oxide, a binder resin, and a heat stabilizer; the charge generating layer includes a binder resin and a phthalocyanine-based charge generating material; and the charge transporting layer includes a charge transporting material, a binder resin, and a heat stabilizer. Also provided is an electrophotographic image forming apparatus including the photoelectrographic photoreceptor. The laminated type electrophotographic photoreceptor includes a predetermined combination of heat stabilizers in the underlayer and the charge transporting layer, and the charge transporting material is a combination of butadiene-based amine compound and hydrazone-based compound, or a benzidine-based compound. Thus, the electrophotographic image forming apparatus including the electrophotographic photoreceptor can stably provide high quality image after repeated use.

### CROSS-REFERENCE TO RELATED PATENT APPLICATION

This application claims the benefit of Korean Patent Application No. 10-2005-0069117, filed on Jul. 28, 2005 in the Korean Intellectual Property Office, the disclosure of which is hereby incorporated by reference in its entirety.

### BACKGROUND OF THE INVENTION

1. Field of the Invention

The present invention relates to an electrophotographic photoreceptor and an electrophotographic image forming apparatus employing the photoreceptor. More particularly, the invention relates to an electrophotographic photoreceptor that prevents image deterioration caused by repeated use and an electrophotographic image forming apparatus employing the photoreceptor.

2. Description of the Related Art

Electrophotography is widely used in laser printers, copy machines, facsimile machines, etc. An electrophotographic photoreceptor includes a photosensitive layer formed on an electrically conductive substrate and can be in the form of a plate, a disk, a sheet, a belt, or a drum, etc. In an electrophotographic photoreceptor, a surface of the photosensitive layer is first electrostatically charged uniformly. Then the charged surface is exposed to a pattern of light, thus forming an image. The light exposure selectively dissipates charges in the exposed regions of the surface irradiated by light, thereby forming a pattern of charged and uncharged regions, which is referred to as a latent image. Then, a wet or dry toner is provided in the vicinity of the latent image, and toner droplets or particles deposit in either the charged or uncharged regions to form a toned image on the surface of the photosensitive layer. The resulting toned image can be transferred and fixed to a suitable final or intermediate receiving surface, such as paper, or the photosensitive layer can function as a final receptor for receiving the image.

Electrophotographic photoreceptors can be classified as a negative charge type and a positive charge type according to the charge type. Negative charge type photoreceptors in which exposure to light is performed after applying negative charges to a photoreceptor surface are widely used at the present time. However, since negative charges produce ozone and have limits to increase the resolution, research has been vigorously conducted on the positive charge type photoreceptors in which exposure to light is performed after applying positive charges to a surface of the photoreceptor.

Photoreceptors can be classified into two types. The first is a laminated type photoreceptor having a two-layer structured photosensitive layer that includes a charge generating layer including a binder resin and a charge generating material (CGM) and a charge transporting layer including a binder resin and a charge transporting material (CTM) (mainly, a hole transporting material (HTM)). The laminated type photoreceptor can have a structure in which a charge generating layer and a charge transporting layer are sequentially formed on an electrically conductive substrate or a structure in which a charge transporting layer and a charge generating layer are sequentially coated on an electrically conductive substrate. In general, the laminated type photoreceptor is used generally in the fabrication of a negative charge type electrophotographic photoreceptor. The other type of photoreceptor is a single-layered type in which a binder resin, a CGM, an HTM, and an electron transporting material (ETM) are contained in a single layer. The single-layered type photoreceptor is generally used in the fabrication of a positive charge type electrophotographic photoreceptor.

The charge generating layer in the laminated type photoreceptor generates electric signals upon exposure to light and contains a CGM and a binder resin. Examples of CGM are organic and inorganic photosensitive pigments. Organic pigments such as azo-based pigments, perylene-based pigments, phthalocyanine-based pigments, etc. are widely used. Since such organic pigments can form various compounds and crystalline structures according to synthesis methods and processing conditions, and thus, electrostatic properties of a photoreceptor can be easily modified. The binder resin disperses and facilitates such a pigment to be uniformly and strongly attached to the electrically conductive substrate. The charge transporting layer transfers electric signals generated in the charge generating layer to the surface of the photoreceptor and includes a CTM, a binder resin, an optional additives, etc.

Such electrophotographic photoreceptors can also be classified into organic photoreceptors and inorganic photoreceptors. Inorganic photoreceptors using an inorganic photoconductive material, such as selenium, zinc oxide, cadmium sulfide, etc., as a main component of the photosensitive layer had been widely used. However, recent attempts have been made to use organic photoreceptors using an organic photoconductive material in the photosensitive layer, and research related thereto has been vigorously conducted. This is because inorganic photoreceptors are disadvantageous in terms of photosensitivity, durability, or environment problems, whereas organic photoreceptors can have various physical properties that can be easily adjusted by changing chemical or crystalline structures of organic photoconductive materials. Also, organic photoreceptors are easy to manufacture and are cheap, and the range of selection for a charge generating material, a charge transporting material, and a binder resin is wide, compared to inorganic photoreceptors.

Examples of organic photoconductive materials having sensitivity to semiconductor laser light include an azo-based compound, a phthalocyanine-based compound, an azulenium-based compound, a pyrylium-based compound, and a naphthoquinone-based compound, and so forth. The phthalocyanine-based compound is frequently used as a charge generating material for its physical and chemical stability and good photosensitivity. Many phthalocyanine-based compounds, such as copper phthalocyanine, metal-free phthalocyanine, chloroaluminum phthalocyanine, chloroindium phthalocyanine, chlorogallium phthalocyanine, chlorogermanium phthalocyanine, oxyvanadyl phthalocyanine, oxytitanyl phthalocyanine, hydroxygermanium phtalocyanine, hydroxygallium phthalocyanine, etc., are known.

Such electrophotographic photoreceptors as describe above undergo image deterioration when repeatedly used because the photosensitive layer deteriorates due to optical fatigue and thermal fatigue when repeatedly used. Such image deterioration is serious especially in an environment of high temperature and high humidity. The image deterioration includes a decrease in image density and other image defects. In order to prevent such image deterioration, an antioxidant and/or a ultraviolet ray absorbent are added, but no satisfactory results have been obtained yet.

Meanwhile, an underlayer can be formed between the electrically conductive substrate and the photosensitive layer. The underlayer improves the adhesion of the substrate and the photosensitive layer, and also prevents image deterioration by suppressing the injection of holes into the photosensitive layer from the electrically conductive substrate and preventing the dielectric breakdown of the photosensitive layer.

Inorganic layers, such as an aluminum anodic oxide film, an aluminum oxide film, and an aluminum hydroxide film, have been used as the underlayer, but recently, underlayers formed of metal oxide particles and a polymer resin binder are used to reduce costs. However, the latter underlayer in which metal oxide particles are dispersed in a binder resin does not sufficiently suppress image deterioration caused due to repeated use.

Examples of conventional electrophotographic photoreceptors including a heat stabilizer in the underlayer and/or charge transporting layer are as follows.

U.S. Pat. No. 4,741,981 discloses an electrophotographic photoreceptor including a charge transporting layer containing an organic phosphite compound and an underlayer containing an organic phosphite compound.

Japanese Patent Laid-Open No. Hei 9-244289 discloses an electrophotographic photoreceptor including an underlayer at least containing a bisazo pigment, a charge generating layer, and a charge transporting layer on an electrically conductive substrate wherein the underlayer contains an antioxidant, such as dilauryl thiopropionate.

However, as is evident in the Examples described below, the conventional electrophotographic photoreceptors cannot effectively prevent image deterioration caused due to repeated use.

### SUMMARY OF THE INVENTION

The present invention provides an electrophotographic photoreceptor that has great resistance to optical fatigue and thermal fatigue, and thus can effectively prevent image deterioration (change in image quality over time) caused by repeated use.

The present invention also provides an electrophotographic image forming apparatus including the above-described electrophotographic photoreceptor with high durability.

According to an aspect of the present invention, an electrophotographic photoreceptor is provided comprising: an underlayer; a charge generating layer; and a charge transporting layer that are sequentially formed on an electrically conductive substrate, wherein the underlayer includes a metal oxide, a binder resin, and a heat stabilizer; the charge generating layer includes a binder resin and a phthalocyanine-based charge generating material; and the charge transporting layer includes a charge transporting material, a binder resin, and a heat stabilizer.

According to another aspect of the present invention, an electrophotographic image forming apparatus is provided comprising: an electrophotographic photoreceptor; a charging apparatus for charging a photosensitive layer of the electrophotographic photoreceptor; an exposing apparatus for forming an electrostatic latent image on a surface of the photosensitive layer of the electrophotographic photoreceptor through exposure to laser light; and a developing apparatus for developing the electrostatic latent image, wherein the electrophotographic photoreceptor comprises: an underlayer; a charge generating layer; and a charge transporting layer that are sequentially formed on an electrically conductive substrate, wherein the underlayer includes a metal oxide, a binder resin, and a heat stabilizer, and the charge generating layer includes a binder resin and a phthalocyanine-based charge generating material, and the charge transporting layer includes a charge transporting material, a binder resin, and a heat stabilizer.

The binder resin in the underlayer may be at least one material selected from the group consisting of polyamide resin, phenol resin, melamine resin, and epoxy resin.

Each of the underlayer and the charge transporting layer may include: 0.01-20% by weight of a phenol-based heat stabilizer based on the weight of the binder resin; 0.01-20% by weight of a mixture of a phenol-based heat stabilizer and a phosphite-based heat stabilizer in a weight ratio of 1:0.1-1:5 based on the weight of the binder resin; or 0.01-20% by weight of a mixture of a phenol-based heat stabilizer and a thioether-based heat stabilizer in a weight ratio of 1:0.1-1:5 based on the weight of the binder resin.

The charge generating material may be a metal-free phthalocyanine-based compound represented by Formula 1 below, a metal phthalocyanine-based compound represented by Formula 2 below, or a mixture of the forgoing compounds,

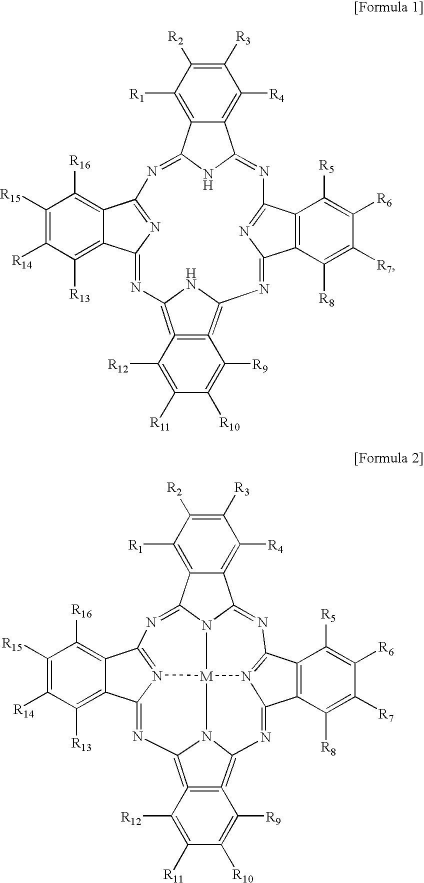

where R₁-R₁₆ are independently selected from the group consisting of a hydrogen atom, a halogen atom, a nitro group, an alkyl group, or an alkoxy group, and M is selected from the group consisting of copper, chloroaluminum, chloroindium, cholorogallium, cholorogermanium, oxyvanadyl, oxytitanyl, hydroxygermanium and hydroxygallium.

In the electrophotographic photoreceptor and the electrophotographic image forming apparatus of the present invention, the binder resin in the charge generating layer may be polyvinyl butyl, and the weight ratio of the charge generating material to the binder resin may be in the range of 1:0.1-1:5.

The binder resin in the charge generating layer may be polycarbonate-Z.

The charge transporting material may be a combination of a butadiene-based amine compound and a hydrazone-based compound, or a benzidine-based compound.

An electrophotographic photoreceptor according to the present invention includes an underlayer, a charge generating layer, and a charge transporting layer that are sequentially formed on an electrically conductive substrate, wherein the underlayer and the charge transporting layer include a predetermined combination of heat stabilizers, and the charge generating layer includes a predetermined combination of phthalocyanine-based pigments. Having excellent optical fatigue resistance and thermal fatigue resistance, the electrophotographic photoreceptor with the above-described structure can suppress image deterioration caused by repeated use which causes optical fatigue and thermal fatigue. Accordingly, an electrophotographic image forming apparatus including the electrophotographic photoreceptor according to the present invention can stably provide a high-quality image even after being repeatedly used.

Considering that optical fatigue occurs in the charge generating layer and the charge transporting layer, but thermal fatigue occurs in all of the underlayer, the charge generating layer, and the charge transporting layer, the inventors concluded that image deterioration can be suppressed by increasing the resistance to optical fatigue and thermal fatigue during repeated use using a predetermined combination of heat stabilizers in the underlayer and the charge transporting layer, and a combination of a butadiene-based amine compound and hydrazone-based compound or a benzidine-based compound as a charge transporting material for the charge transporting layer.

These and other aspects of the invention will become apparent from the following detailed description of the invention which, taken in conjunction with the annexed drawing, disclose various embodiments of the invention.

### BRIEF DESCRIPTION OF THE DRAWING

The above and other features and advantages of the present invention will become more apparent by describing in detail exemplary embodiments thereof with reference to the attached drawing in which:

FIG. 1 is a schematic view of an electrophotographic image forming apparatus according to an embodiment of the present invention.

### DETAILED DESCRIPTION OF THE INVENTION

The present invention will now be described more fully with reference to the accompanying drawing, in which exemplary embodiments of the invention are shown.

A photoreceptor according to an embodiment of the present invention includes an underlayer, a charge generating layer, and a charge transporting layer that are sequentially formed on an electrically conductive substrate. The electrically conductive substrate may be formed of a metal, such as aluminum, aluminum alloy, stainless steel, copper, nickel, etc. The electrically conductive substrate can include an insulating substrate, such as polyester film, paper, glass, etc. with a conductive layer on its surface. The conductive layer can be made of, for example, aluminum, palladium, tin oxide, indium oxide, etc. The electrically conductive substrate can be in the form of a drum, pipe, belt, plate, etc.

The underlayer is formed between the electrically conductive substrate and the charge generating layer. The underlayer includes a metal oxide particle, a binder resin, and a heat stabilizer. Examples of the metal oxide include tin oxide, indium oxide, zinc oxide, titanium oxide, silicon oxide, zirconium oxide, and aluminum oxide, which may be used alone or in combinations of two or more. Examples of the binder resin include a thermosetting resin that is obtained by thermally polymerizing oil-free alkyd resin, an amino resin, such as butylated melamine resin, a photocurable resin that is obtained by polymerizing a resin having an unsaturated bond, such as unsaturated polyester or unsaturated polyurethane, a polyamide resin, a polyurethane resin, an epoxy resin, etc., which may be used alone or in combinations of two or more. The thickness of the underlayer may be 0.1-20 μm, preferably 0.2-10 μm. When the thickness of the underlayer is less than 0.1 μm, the underlayer is damaged by a high voltage and thus may be perforated and lead to black spots in an image. When the thickness of the underlayer is larger than 20 μm, it is difficult to control the electrostatic characteristics of the underlayer and the image quality degradations.

The weight ratio of the metal oxide to the binder resin in the underlayer may be in the range of 0.1:1-10:1. When the portion of the binder is too high, the blocking ability of the metal oxide decreases. When the portion of the metal oxide is too high, the adhesion of the underlayer is low when the underlayer is coated on the photoreceptor drum.

The underlayer further includes a heat stabilizer, in addition to the metal oxide particle and the binder resin. Examples of the heat stabilizer that can be used in the underlayer include a phenol-based heat stabilizer, a phosphite-based heat stabilizer, a thioether-based heat stabilizer, etc. The amount of the heat stabilizer in the underlayer may be in the range of 0.01-20% by weight, preferably 0.01-10% by weight, based on the weight of the binder resin. When the amount of the heat stabilizer is too small, the effect of preventing image deterioration caused by repeated use is not substantially obtained. When the amount of the heat stabilizer is too large, the stabilizing effect of preventing image deterioration does not increase, and the cost becomes high.

Examples of the phenol-based heat stabilizer include 2,6-di-tert-butylphenol, 2,6-di-tert-butyl-4-methoxyphenol, 2,6-di-tert-butyl-4-methyl phenol, 2-tert-butyl-4-methoxyphenol, 2,4-dimethyl-6-tert-butylphenol, 2-tert-butylphenol, 3,6-di-tert-butylphenol, 2,4-di-tert-butylphenol, 2,6-di-tert-butyl-4-ethylphenol, 2-tert-butyl-4,6-methyl phenol, 2,4,6-tert-butylphenol, 2,6-di-tert-butyl-4-stearyl propionate phenol, α-tocopherol, β-tocopherol, γ-tocopherol, naphthol AS, naphthol AS-D, naphthol AS-BO, 4,4′-methylenebis(2,6-di-tert-butylphenol), 4,4′-methylenebis(6-tert-butyl-4-methyl phenol), 2,2′-methylenebis(4-methyl-6-tert-butylphenol), 2,2′-methylenebis(4-ethyl-6-tert-butylphenol), 2,2′-ethylene bis(4,6-di-tert-butylphenol), 2,2′-propylene bis (4,6-di-tert-butylphenol), 2,2′-butane bis(4,6-di-tert-butylphenol), 2,2′-ethylene bis (6-tert-butyl-m-cresol), 4,4′-butane bis(6-tert-butyl-m-cresol), 2,2′-butane bis((6-tert-butyl-p-cresol), 2,2′-thiobis((6-tert-butylphenol), 4,4′-thiobis(6-tert-butyl-m-cresol), 4,4′-thiobis(6-tert-o-cresol), 2,2′-thiobis(4-methyl-6-tert-butylphenol), 1,3,5-trimethyl-2,4,6-tris(3,5-di-tert-butyl-4-hydroxybenzyl)benzene, 1,3,5-trimethyl-2,4,6-tris(3,5-di-tert-amyl-4-hydroxybenzyl)benzene, 1,3,5-trimethyl-2,4,6-tris(3-tert-butyl-5-methyl-4-hydroxybenzyl)benzene, 2-tert-butyl-5-methyl-phenyl amine phenol, 4,4′-bis amino(2-tert-butyl-4-methyl phenol), n-octadecyl-3-(3′,5′-di-tert-butyl-4′-hydroxyphenyl)propionate, 2,2,4-trimethyl-6-hydroxy-7-tert-butyl chroman, tetrakis(methylene-3(3,5-di-tert-butyl-4-hydroxyphenyl)propionate) methane, 1,1,3-tris (2-methyl-4-hydroxy-5-tert-butylphenyl)butane, etc., but are not limited thereto.

Examples of the phosphite-based heat stabilizer include trimethyl phosphite, triethyl phosphite, tri-n-butyl phosphite, trioctyl phosphite, tridecyl phosphite, tridodecyl phosphite, tristearyl phosphite, trioleyl phosphite, tris-tridecyl phosphite, tri cetyl phosphite, dilaurylhydrodiene phosphite, diphenylmonodecyl phosphite, diphenylmono(tridecyl) phosphite, tetraphenyldipropylene glycol phosphite, 4,4′-butylidene-bis (3-methyl-6-t-phenyl-di-tridecyl)phosphite, distearyl pentaerythritol disphosphite, ditridecyl pentaerythritol disphosphite, dinonylphenyl pentaerythritol disphosphite, diphenyloctyl phosphite, tetra(tridecyl)-4,4′-isopropylidenediphenyl diphosphite, tris(2,4-di-t-butylphenyl)phosphite, tris(2,4-di-t-amylphenyl)phosphite, tris (2-tert-butyl-4-methylphenyl)phosphite, tris(2-ethyl-4-methylphenyl)phosphite, tris (4-nonylphenyl)phosphite, di(2,4-di-t-butylphenyl)pentaerythritol disphosphite, di (nonylphenyl)pentaerythritol disphosphite, tris(nonylphenyl)phosphite, tris(p-tert-octylphenyl)phosphite, tris(p-2-butenylphenyl)phosphite, bis(p-nonylphenyl)cyclohexyl phosphite, tetrakis(2,4-di-tert-butylphenyl)-4,4′-biphenylene diphosphite, 2,6-di-tert-butyl-4-methyl phenyl phenyl pentaerythritol disphosphite, 2,6-di-tert-butyl-4-ethylphenyl stearyl pentaerythritol disphosphite, di(2,6-di-tert-butyl-4-methyl phenyl)pentaerythritol disphosphite, 2,6-di-tert-amyl-4-methylphenyl phenylpentaerythritol disphosphite, etc., but are not limited thereto. Also, trivalent phosphorous compounds, such as Compounds (1) through (7) below, can be used.

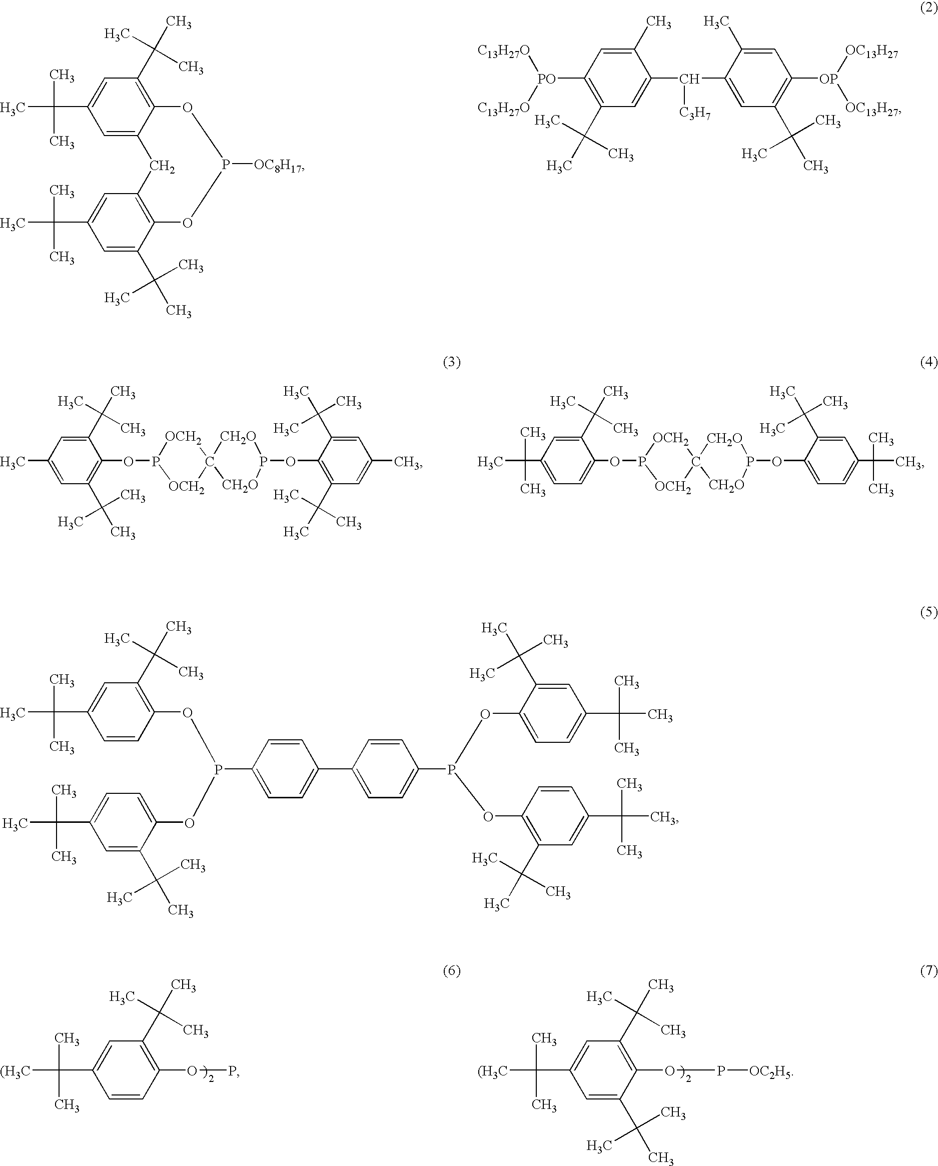

Examples of the thioether-based heat stabilizer include dilauryl thiodipropionate, dimyristyl thiodipropyonate, laurylstearyl thiodipropionate, distearyl thiodipropionate, dimethyl thiodipropionate, 2-mercaptobenzimidazole, phenothiazine, octadecyl thioglycolate, butyl thioglycolate, octyl thioglycolate, a thiocresol, etc., but are not limited thereto. Also, organic sulfide heat stabilizers, such as Compounds (8) and (9) below, can be used.

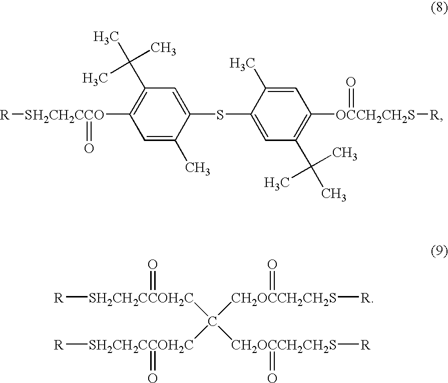

In Compounds (8) and (9), R is a C₁₂₋₁₄ alkyl group.

The above-described heat stabilizer may be used alone or in combinations of at least two according to the need and desired result. For example, a phenol-based heat stabilizer may be used alone, or a mixture of a phenol-based heat stabilizer and a phosphite-based heat stabilizer in a weight ratio of 1:0.1-1:5 or a mixture of a phenol-based heat stabilizer and a thioether-based heat stabilizer in a weight ratio of 1:0.1-1:5 may be used. The phenol-based heat stabilizer provides a heat stabilizing effect by functioning as a radical remover or scavenger, and the phosphite-based heat stabilizer and the thioether-based heat stabilizer provides a heat stabilizing effect by functioning as peroxide resolvents. Accordingly, when using a mixture of these heat stabilizers, a synergistic effect can be obtained. In addition, an amine-based heat stabilizer can also be used.

In some cases, an anodic oxide thin film, such as an alumite thin film, or a binder layer composed of, such as polyamide, polyurethane, epoxy resin, etc, may be coated between the electrically conductive substrate and the underlayer.

The charge generating layer formed on the underlayer includes a binder resin and a charge generating material dispersed or dissolved in the binder resin. Examples of the charge generating material that can be used in the present invention include organic pigments, such as a phthalocyanine-based pigment, a perylene-based pigment, a perinone-based compound, an indigo-based pigment, a quinacridone-based pigment, an azo-based pigment, a bisazo-based pigment, a trisazo-based pigment, a bisbenzoimidazole-based pigment, polycycloquinone, a pyrrolopyrrol compound, a metal-free naphthalocyanine pigment, a metal naphthalocyanine-based pigment, a squaline-based pigment, a squarylium-based pigment, an azulenium-based pigment, a quinine-based pigment, a cyanine-based pigment, a pyryllium-based pigment, an anthraquinone-based pigment, a triphenylmethane-based pigment, a threne-based pigment, a toluidine-based pigment, a pyazoline-based pigment, and a mixture of at least two of these materials. A metal-free phthalocyanine-based pigment represented by Formula 1 below, a metal phthalocyanine-based pigment represented by Formula 2 below, or a mixture of these pigments may be used. When a mixture of the pigments represented by Formulas 1 and 2 is used, a photoreceptor having a desired absorption wavelength range can be manufactured, and there is also a complementary effect therebetween.

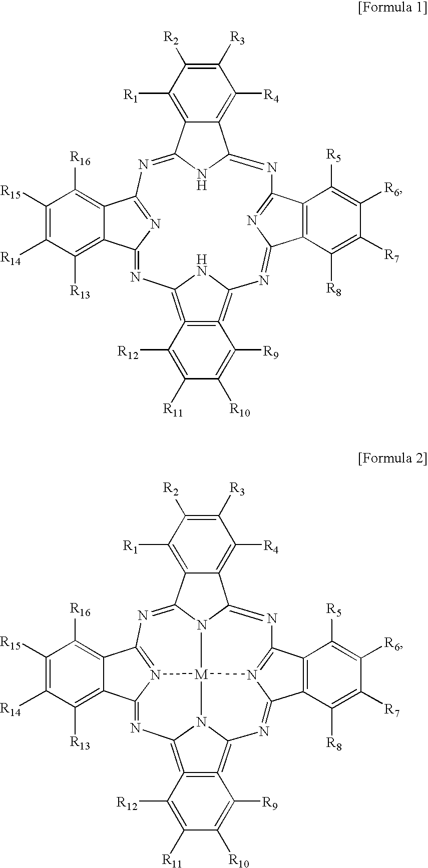

Here, R₁ through R₁₆ are independently a hydrogen atom, a halogen atom, a nitro group, an alkyl group, or an alkoxy group, and M is a material selected from the group consisting of copper, chloroaluminum, chloroindium, chlorogallium, chlorogermanium, oxyvanadyl, oxytitanyl, hydroxygermanium, and hydroxygallium.

The alkyl group is a C₁-C₂₀ linear or branched alkyl group, preferably a C₁-C₁₂ linear or branched alkyl group. Examples of the alkyl group include methyl, ethyl, n-propyl, isopropyl, n-butyl, isobutyl, sec-butyl, tert-butyl, pentyl, hexyl, 1,2-dimethyl-propyl, and 2-ethylhexyl. The alkyl group may be substituted with a halogen atom, an alkyl group, an aryl group, an alkoxy group, a nitro group, a hydroxy group, or a sulfonic acid group.

The alkoxy group is a C₁-C₂₀ linear or branched alkoxy group, and preferably a C₁-C₁₂ linear or branched alkoxy group. Examples of the alkoxy group include methoxy, ethoxy, propoxy, and the like. The alkoxy group may be substituted with a halogen atom, an alkyl group, an aryl group, an alkoxy group, a nitro group, a hydroxy group, or a sulfonic acid group.

The crystal structures of the phthalocyanine pigments of Formulas 1 and 2 used in the present invention are not limited. However, in consideration of an improvement in photosensitivity and dispersion stability, the metal-free phthalocyanine pigment may have an X-type or tau(T)-type crystal structure, and the metal phthalocyanine pigment may have a Y-type or α-type oxytitanyl phthalocyanine.

When a phthalocyanine-based compound is used as a charge generating material of the charge generating layer in the present invention, a different charge generating material as described above can be used together for the adjustment of spectral sensitivity. Also, an electron accepting material may be further included for sensitivity improvement, residual potential reduction and/or reduction in fatigue accumulated due to repeated use. Examples of the electron accepting material with high electron affinity include succinic anhydride, maleic anhydride, dibrome-succinic anhydride, phthalic anhydride, 3-nitro phthalic anhydride, 4-nitro phthalic anhydride, pyromellitic anhydride, pyromellitic acid, trimellitic acid, trimellitic anhydride, phthalimide, 4-nitrophthalimide, tetracyanoethylene, tetracyano quinodimethane, chloranyl, bromanil, o-nitro benzoic acid, and p-nitro benzoic acid. The amount of the electron accepting material may be in the range of 0.01-100% by weight based on the weight of the charge generating material.

The thickness of the charge generating layer may be in the range of 0.01-10 μm, preferably, 0.05-3 μm. When the thickness of the charge generating layer is smaller than 0.01 μm, it is difficult to uniformly form the charge generating layer and the sensitivity and the mechanical durability are not sufficient. When the thickness of the charge generating layer is larger than 10 μm, electrophotographic characteristics are likely to degrade.

The amount of the charge generating material and the amount of the binder resin in the charge generating layer are not limited and can be determined within an allowable range known in the art according to the particular needs. For example, the ratio of the charge generating material to the binder resin in the charge generating layer may be 1:0.1-1:5. When the amount of the charge generating material is small, the amount of generated charges is not sufficient, and thus the sensitivity is not sufficient and the residual potential is likely to increase. When the amount of the charge generating material is large, the amount of the resin in the photosensitive layer is relatively small, and thus the mechanical strength and the dispersion stability of the charge generating material are likely to decrease. When the charge generating material has a film-forming ability, the binder resin may not be needed.

The charge transporting layer is formed on the charge generating layer. The charge transporting layer includes a binder resin, a heat stabilizer, and a charge transporting material dispersed or dissolved in the binder resin. Examples of the charge transporting material include a hole transporting material and an electron transporting material. When the laminated type photoreceptor is a negative charge type, a hole transporting material is used as a main component of the charge transporting layer. When the laminated type photoreceptor is a positive charge type, an electron transporting material is used as a main component of the charge transporting layer. When the laminated type photoreceptor needs to have bipolarity, i.e., sometimes positively charged and sometimes negatively charged depending on the needs, a combination of a hole transporting material and an electron transporting material can be used. When the charge transporting material has a film-forming ability, the binder resin may not be needed. However, when a low-molecular weight charge transporting material that cannot form a film, the binder resin has to be used.

The thickness of the charge transporting layer may be in the range of 2-100 μm, for example 5-50 μm, such as 10-40 μm. When the thickness of the charge transporting layer is smaller than 2 μm, the charge transporting layer is too thin to provide its inherent effect. When the thickness of the charge transporting layer is larger than 100 μm, the quality of a printed image is likely to degrade. The amounts of the binder resin and the charge transporting material in the charge transporting layer in the present invention are not limited, and can be determined within an allowable range known in the art. For example, the amount of the charge transporting material may be in the range of 10-200 parts by weight, for example, 20-150 parts by weight, based on 100 parts by weight of the binder resin. When the amount of the charge transporting material is smaller than 10 parts by weight, the charge transporting capability is insufficient, and thus the sensitivity is insufficient and the residual potential is likely to increase. When the amount of the charge transporting material is larger than 200 parts by weight, the amount of the resin in the photosensitive layer is relatively small, and thus the mechanical strength is likely to decrease.

The charge transporting layer also includes a heat stabilizer. The type and amount of the heat stabilizer that can be used in the charge transporting layer are the same as described above in connection with the underlayer.

The charge transporting material dispersed or dissolved in the binder resin in the charge transporting layer may be at least one of a hole transporting material and an electron transporting material. Examples of low-molecular weight compounds that can be used as the hole transporting material include a pyrene-based compound, a carbazole-based compound, a hydrazone-based compound, an oxazole-based compound, an oxadiazol-based compound, a pyrazolin-based compound, an arylamine-based compound, an arylmethane-based compound, a benzidine-based compound, a thiazole-based compound, a styryl-based compound, a stilbene-based compound, a butadiene-based compound, and a butadiene-based amine compound. Examples of polymer compounds that can be used as the hole transporting material include polyarylalkane, polyvinyl carbazole, halogenated polyvinyl carbazole, polyvinylpyrene, polyvinyl anthracene, polyvinyl acridine, a formaldehyde-based condensation resin, such as, a pyrene-formaldehyde resin and an ethylcarbazole-formaldehyde resin, a triphenylmethane polymer, polysilane, an N-acrylamide methylcarbazole polymer, a triphenylmethane polymer, a styrene copolymer, polyacenaphthene, polyindene, and a copolymer of acenaphthylene and styrene. Examples of the electron transporting material include electron absorbing low-molecular weight compounds, such as a benzoquinone-based compound, a naphthoquinone-based compound, an anthraquinone-based compound, a malononitrile-based compound, a fluorenone-based compound, a dicyanofluorenone-based compound, a benzoquinoneimine-based compound, a diphenoquinone-based compound, a stilbene quinine-based compound, a diiminoquinone-based compound, a dioxotetracenedione-based compound, a thiopyran-based compound, a tetracyanoethylene-based compound, a tetracyanoquinodimethane-based compound, a xanthone-based compound, a phenanthraquinone-based compound, a phthalic anhydride-based compound, a naphthalene-based compound, etc. However, examples of the electron transporting material are not limited to the above. Polymer compounds or pigments that can transport electrons also can be used. The above-described charge transporting materials may be used alone or in combinations of at least two in the electrophotographic photoreceptor according to the present invention. In addition to the above-described hole transporting materials and electron transporting materials, any material having a charge mobility of 10⁻⁸ cm²/s or greater may be used. As described above, the above-described charge transporting materials may be used alone or in combinations of two or more in the electrophotographic photoreceptor according to the present invention. The inventors repeatedly performed experiments and discovered that use of a combination of a butadiene-based amine compound and a hydrazone-based compound, or a benzidine-based compound as the charge transporting material is more effective to suppress image deterioration caused by repeated use of the photoreceptor. Accordingly, the charge transporting material may be a combination of a butadiene-based amine compound and a hydrazone-based compound, or a benzidine-based compound.

The binder resin that can be used in the underlayer, the charge generating layer, and the charge transporting layer of the electrophotographic photoreceptor according to the present invention may be any insulating resin having a film-forming ability. Specific examples of the binder resin include polycarbonate, polyarylate (such as a condensed polymer of bisphenol A and phthalic acid), polyamide, polyester, acrylic resin, methacrylic resin, polyvinyl chloride, polyvinylidene chloride, polystyrene, polyvinyl acetate, a styrene-butadiene copolymer, a vinylidene chloride-acrylonitrile copolymer, a vinyl chloride-vinyl acetate copolymer, a vinyl chloride-vinyl acetate-maleic anhydride copolymer, silicone resin, a silicone-alkyd resin, a phenol-formaldehyde resin, a styrene-alkyd resin, a polyvinyl acetal, such as polyvinyl butyral and polyvinyl formal, polysulfone, casein, gelatin, polyvinyl alcohol, a cellulose-based resin, such as ethyl cellulose and carboxymethyl cellulose, polyurethane, a polyacrylamide resin, polyvinyl pyridine, an epoxy resin, polyketone, polyacrylonitrile, a melamine resin, polyvinyl pyrrolidone, etc., but are not limited thereto. These binder resins may be used alone or in combinations of two or more. Organic photoconductive resins, such as poly N-vinylcarbazole, polyvinyl anthracene, polyvinylpyrene, etc., also may be used.

The binder resin of the charge transporting layer, which is a surface layer of the photosensitive layer may be a polycarbonate resin, and in particular, polycarbonate-Z derived from cyclohexylidene bisphenol, rather than polycarbonate-A derived from methylbisphenol A or polycarbonate-C derived from methylbisphenol A, because the polycarbonate-Z derivative has a high glass transition temperature and high wear resistance.

Solvents of coating solutions used to form the underlayer, the charge generating layer, and the charge transporting layer of the electrophotographic photoreceptor according to the present invention vary according to the type of the resin and may be selected to prevent an adverse affect on an adjacent layer during coating.

Examples of such solvents include: aromatic hydrocarbons, such as benzene, xylene, ligroin, monochlorobenzene, dichlorobenzene, etc.; ketones, such as acetone, methylethyl ketone, cyclohexanone, etc.; alcohols, such as methanol, ethanol, isopropanol, etc.; esters, such as ethyl acetate, methyl cellosolve, etc.; aliphatic halogenated hydrocarbons, such as carbon tetrachloride, chloroform, dichloromethane, dichloroethane, trichloroethylene, etc.; ethers, such as tetrahydrofurane, dioxane, dioxolane, ethylene glycol monomethyl ether, etc.; amides, such as N,N-dimethylformamide, N,N-dimethyl acetamide, etc.; and sulfoxides, such as dimethyl sulfoxide, etc. These solvents may be used alone or in combinations of two or more.

The underlayer, the charge generating layer, and the charge transporting layer of the electrophotographic photoreceptor according to the present invention can be obtained by coating a homogeneous coating solution containing such a component in an amount as described above on an electrically conductive substrate and drying the coated solution. A dispersion apparatus that is used to obtain the homogeneous coating solution can be any apparatus commonly known in the field of pigment and ink. For example, an attritor, a ball-mill, a sand-mill, a high-speed mixer, a Banbury mixer, a roll-mill, a three-roll mill, a nanomizer, a microfluidizer, a stamp mill, a planetary mill, a vibration mill, a kneader, etc., can be used. Glass beads, steel beads, zirconium oxide beads, aluminum oxide balls, zirconium oxide balls, flint stone may be used as the dispersion apparatus according to needs. Homogeneous coating solutions obtained using such a dispersion apparatus are coated on an electrically conductive substrate-using a conventional coating apparatus, such as a dip-coater, a spray coater, a wire-bar coater, an applicator, a doctor blade, a roller coater, a curtain coater, or a bead coater to predetermined thicknesses and dried to complete an electrophotographic photoreceptor of the present invention.

Together with the binder resin, an additive, such as a dispersion stabilizer, a plasticizer, a surface modifier, or a photodeterioration inhibitor may be added to form the underlayer, the charge generating layer, and the charge transporting layer.

Examples of the plasticizer include biphenyl, chlorinated biphenyl, terphenyl, dibutyl phthalate, diethylene glycol phthalate, dioctyl phthalate, triphenyl phosphite, methylnaphthalene, benzophenone, chlorinated paraffin, polypropylene, polystyrene, various fluorinated hydrocarbons, etc., but are not limited thereto.

Examples of the surface modifier include silicone oil, fluorine resin, etc.

Examples of the photodeterioration inhibitor include a benzotriazole-based compound, a benzophenone-based compound, a hindered amine-based compound, etc.

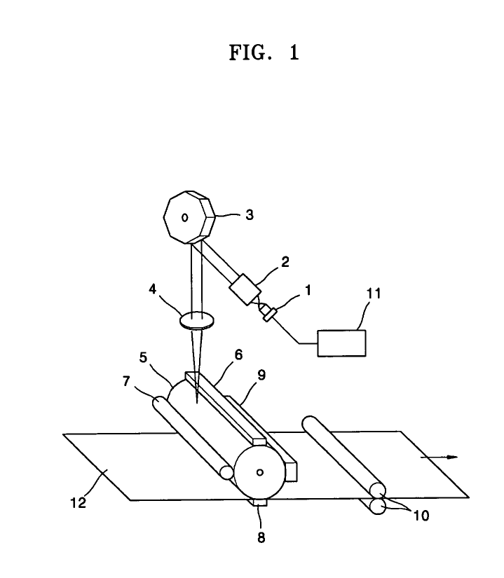

FIG. 1 is a schematic view of an electrophotographic image forming apparatus according to an embodiment of the present invention. Referring to FIG. 1, reference numeral 1 indicates a semiconductor laser. Laser light that is signal-modulated by a control circuit 11 according to image information, after being radiated is collimated by an optical correction system 2 and performs scanning while being reflected by a polygonal rotatory mirror 3. The laser light is focused on a surface of an electrophotographic photoreceptor 5 by a scanning lens 4 to expose a region of the surface according to the image information. The electrophotographic photoreceptor is previously charged by a charging apparatus 6 so that an electrostatic latent image is formed on the surface through the exposure process and then formed into a toner image by a developing apparatus 7. The toner image is transferred to an image receptor 12, such as paper, by a transferring apparatus 8, and fixed as a print result by a fixing apparatus 10. The electrophotographic photoreceptor can be repeatedly used by removing a coloring agent remaining on the surface thereof using a cleaning apparatus 9. Although the electrophotographic photoreceptor in FIG. 1 is a drum type, an electrophotographic photoreceptor according to the present invention can be formed as a plate or a belt.

Hereinafter, the present invention will be described in detail with reference to the following examples. However, the following examples are for illustrative purpose only and are not intended to limit the scope of the invention.

### EXAMPLE 1

80 parts by weight of Nylon resin (“CM 8000” manufactured by Toray Industries, Co.,) was dissolved in 320 parts by weight of an organic solvent (methanol: isopropanol, 1:1 (weight ratio)). 4000 parts by weight of alumina balls (5 mmΦ), 80 parts by weight of titanium oxide (TTO-55N manufactured by Ishihara Industries, Co., an average primary diameter of about 35 nm), and 0.01 parts by weight of 2,6-di-tert-butyl-4-methyl phenol (manufactured by Aldrich) as a phenol-based heat stabilizer were added to the resulting solution and dispersed by ball-milling for 20 hours. The resulting dispersion solution was diluted with 1,120 parts by weight of the organic solvent to prepare a coating solution for a stable underlayer.

The coating solution for an underlayer was coated on an aluminum drum having an outer diameter of 24 mm Φ, a length of 236 mm, and a thickness of 1 mm and dried in an oven at 120° C. to form the underlayer.

5 parts by weight of metal-free phthalocyanine (“TPA-891” manufactured by Japanese Materials Co., Ltd.), 2.5 parts by weight of polyvinyl butyral resin (“6000C” manufactured by Denki Kagaku Kogyo K.K.), and 80 parts by weight of tetrahydrofurane (THF) were dispersed together with alkali glass beads having a diameter of 1-1.5 mm using a paint shaker for 60 minutes, and then THF 272 was added to the dispersion to prepare a coating solution for a charge generating layer. The coating solution was coated on the underlayer to a thickness of 0.2-0.5 μm and dried in an oven at 120° C. for 30 minutes to form the charge generating layer.

4.2 parts by weight of 4-dibenzylamino-2-methylbenzaldehyde diphenylhydrazone (“CTC191” manufactured by Takasago International Corporation), 4.2 parts by weight of 1,1-bis-(p-diethylaminophenyl)-4,4-diphenyl-1,3-butadiene (“T-405” manufactured by Takasago International Corporation), 10.5 parts by weight of polycarbonate resin (“TS-2050” manufactured by Teijin Ltd.), 0.4 parts by weight of 2,6-di-tert-butyl-4-methyl phenol as a heat stabilizer, and 0.004 parts by weight of silicone oil (“KF-50” manufactured by Shinetsu Chemical Co., Ltd.) were dissolved in a mixed solvent of 70 parts by weight of THF and 8.6 parts of toluene to prepare a coating solution for a charge transporting layer. The coating solution was coated on the charge generating layer to form the charge transporting layer having a thickness of 15-35 μm and dried in an oven at 120° C. for 30 minutes to form a negative charge type laminated photoreceptor drum.

### EXAMPLE 2

A laminated type photoreceptor drum was prepared in the same manner as in Example 1, except that 0.01 parts by weight of n-octadecyl-3-(3′,5′-di-tert-butyl-4′-hydroxyphenyl)propionate was used as the heat stabilizer to prepare a coating solution for the underlayer instead of 0.01 parts by weight of 2,6-di-tert-butyl-4-methyl phenol.

### EXAMPLE 3

A laminated type photoreceptor drum was prepared in the same manner as in Example 1, except that 0.01 parts by weight of tetrakis(methylene-3(3,5-di-tert-butyl-4-hydroxyphenyl)propionate) methane was used as the heat stabilizer to prepare a coating solution for the underlayer instead of 0.01 parts by weight of 2,6-di-tert-butyl-4-methyl phenol.

### EXAMPLE 4

A laminated type photoreceptor drum was prepared in the same manner as in Example 1, except that 16 parts by weight of 2,6-di-tert-butyl-4-methyl phenol was used as the heat stabilizer to manufacture a coating solution for the underlayer instead of 0.01 parts by weight of 2,6-di-tert-butyl-4-methyl phenol.

### EXAMPLE 5

A laminated type photoreceptor drum was prepared in the same manner as in Example 1, except that 16 parts by weight of n-octadecyl-3-(3′,5′-di-tert-butyl-4′-hydroxyphenyl)propionate was used as the heat stabilizer to prepare a coating solution for the underlayer instead of 0.01 parts by weight of 2,6-di-tert-butyl-4-methyl phenol.

### EXAMPLE 6

A laminated type photoreceptor drum was prepared in the same manner as in Example 1, except that 16 parts by weight of tetrakis(methylene-3(3,5-di-tert-butyl-4-hydroxyphenyl)propionate) methane was used as the heat stabilizer to manufacture a coating solution for the underlayer instead of 0.01 parts by weight of 2,6-di-tert-butyl-4-methyl phenol.

### EXAMPLE 7

A laminated type photoreceptor drum was prepared in the same manner as in Example 1, except that 0.008 parts by weight of 2,6-di-tert-butyl-4-methyl phenol and 0.004 parts by weight of compound (1) were used as the heat stabilizer to prepare a coating solution for the underlayer instead of 0.01 parts by weight of 2,6-di-tert-butyl-4-methyl phenol.

### EXAMPLE 8

A laminated type photoreceptor drum was prepared in the same manner as in Example 1, except that 0.008 parts by weight of 2,6-di-tert-butyl-4-methyl phenol and 0.004 parts by weight of compound (2) were used as the heat stabilizer to prepare a coating solution for the underlayer instead of 0.01 parts by weight of 2,6-di-tert-butyl-4-methyl phenol.

### EXAMPLE 9

A laminated type photoreceptor drum was prepared in the same manner as in Example 1, except that 0.008 parts by weight of 2,6-di-tert-butyl-4-methyl phenol and 0.004 parts by weight of compound (6) were used as the heat stabilizer to prepare a coating solution for the underlayer instead of 0.01 parts by weight of 2,6-di-tert-butyl-4-methyl phenol.

### EXAMPLE 10

A laminated type photoreceptor drum was prepared in the same manner as in Example 1, except that 0.008 parts by weight of 2,6-di-tert-butyl-4-methyl phenol and 0.004 parts by weight of compound (7) were used as the heat stabilizer to prepare a coating solution for the underlayer instead of 0.01 parts by weight of 2,6-di-tert-butyl-4-methyl phenol.

### EXAMPLE 11

A laminated type photoreceptor drum was prepared in the same manner as in Example 1, except that 0.002 parts by weight of 2,6-di-tert-butyl-4-methyl phenol and 0.007 parts by weight of Compound (1) were used as the heat stabilizer to prepare a coating solution for the underlayer instead of 0.01 parts by weight of 2,6-di-tert-butyl-4-methyl phenol.

### EXAMPLE 12

A laminated type photoreceptor drum was prepared in the same manner as in Example 1, except that 0.002 parts by weight of 2,6-di-tert-butyl-4-methyl phenol and 0.007 parts by weight of Compound (6) were used as the heat stabilizer to prepare a coating solution for the underlayer instead of 0.01 parts by weight of 2,6-di-tert-butyl-4-methyl phenol.

### EXAMPLE 13

A laminated type photoreceptor drum was prepared in the same manner as in Example 1, except that 10 parts by weight of 2,6-di-tert-butyl-4-methyl phenol and 5 parts by weight of Compound (6) were used as the heat stabilizer to prepare a coating solution for the underlayer instead of 0.01 parts by weight of 2,6-di-tert-butyl-4-methyl phenol.

### EXAMPLE 14

A laminated type photoreceptor drum was prepared in the same manner as in Example 1, except that 3 parts by weight of 2,6-di-tert-butyl-4-methyl phenol and 13 parts by weight of Compound (6) were used as the heat stabilizer to prepare a coating solution for the underlayer instead of 0.01 parts by weight of 2,6-di-tert-butyl-4-methyl phenol.

### EXAMPLE 15

A laminated type photoreceptor drum was prepared in the same manner as in Example 1, except that 0.008 parts by weight of 2,6-di-tert-butyl-4-methyl phenol and 0.004 parts by weight of Compound (8) were used as the heat stabilizer to prepare a coating solution for the underlayer instead of 0.01 parts by weight of 2,6-di-tert-butyl-4-methyl phenol.

### EXAMPLE 16

A laminated type photoreceptor drum was prepared in the same manner as in Example 1, except that 0.008 parts by weight of 2,6-di-tert-butyl-4-methyl phenol and 0.004 parts by weight of Compound (9) were used as the heat stabilizer to prepare a coating solution for the underlayer instead of 0.01 parts by weight of 2,6-di-tert-butyl-4-methyl phenol.

### EXAMPLE 17

A laminated type photoreceptor drum was prepared in the same manner as in Example 1, except that 0.002 parts by weight of 2,6-di-tert-butyl-4-methyl phenol and 0.007 parts by weight of Compound (8) were used as the heat stabilizer to prepare a coating solution for the underlayer instead of 0.01 parts by weight of 2,6-di-tert-butyl-4-methyl phenol.

### EXAMPLE 18

A laminated type photoreceptor drum was prepared in the same manner as in Example 1, except that 10 parts by weight of 2,6-di-tert-butyl-4-methyl phenol and 5 parts by weight of Compound (8) were used as the heat stabilizer to prepare a coating solution for the underlayer instead of 0.01 parts by weight of 2,6-di-tert-butyl-4-methyl phenol.

### EXAMPLE 19

A laminated type photoreceptor drum was prepared in the same manner as in Example 1, except that 3 parts by weight of 2,6-di-tert-butyl-4-methyl phenol and 13 parts by weight of Compound (8) were used as the heat stabilizer to prepare a coating solution for the underlayer instead of 0.01 parts by weight of 2,6-di-tert-butyl-4-methyl phenol.

### EXAMPLE 20

A laminated type photoreceptor drum was prepared in the same manner as in Example 1, except that 0.2 parts by weight of 2,6-di-tert-butyl-4-methyl phenol and 0.2 parts by weight of Compound (1) were used as the heat stabilizer to prepare a coating solution for the charge transporting layer instead of 0.4 parts by weight of 2,6-di-tert-butyl-4-methyl phenol.

### EXAMPLE 21

A laminated type photoreceptor drum was prepared in the same manner as in Example 1, except that 0.2 parts by weight of 2,6-di-tert-butyl-4-methyl phenol and 0.2 parts by weight of Compound (6) were used as the heat stabilizer to prepare a coating solution for the charge transporting layer instead of 0.4 parts by weight of 2,6-di-tert-butyl-4-methyl phenol.

### EXAMPLE 22

A laminated type photoreceptor drum was prepared in the same manner as in Example 1, except that 0.2 parts by weight of 2,6-di-tert-butyl-4-methyl phenol and 0.2 parts by weight of Compound (8) were used as the heat stabilizer to prepare a coating solution for the charge transporting layer instead of 0.4 parts by weight of 2,6-di-tert-butyl-4-methyl phenol.

### EXAMPLE 23

A laminated type photoreceptor drum was prepared in the same manner as in Example 1, except that 8.4 parts by weight of N,N′-bis(3-methyl phenyl)-N, N′-bis(phenyl)benzidine was used to prepare a coating solution for the charge transporting layer instead of 4.2 parts by weight of 4-dibenzylamino-2-methylbenzaldehyde diphenylhydrazone, and 4.2 parts by weight of 1,1-bis-(p-diethylaminophenyl)-4,4-diphenyl-1,3-butadiene.

### COMPARATIVE EXAMPLE 1

A laminated type photoreceptor drum was prepared in the same manner as in Example 1, except that 2,6-di-tert-butyl-4-methyl phenol was not used to prepare the coating solution for the underlayer.

### COMPARATIVE EXAMPLE 2

A laminated type photoreceptor drum was prepared in the same manner as in Example 1, except that 0.01 parts by weight of Compound (1) was used instead of 0.01 parts by weight of 2,6-di-tert-butyl-4-methyl phenol.

### COMPARATIVE EXAMPLE 3

A laminated type photoreceptor drum was prepared in the same manner as in Example 1, except that 16 parts by weight of Compound (1) was used to prepare a coating solution for the underlayer instead of 0.01 parts by weight of 2,6-di-tert-butyl-4-methyl phenol.

### COMPARATIVE EXAMPLE 4

A laminated type photoreceptor drum was prepared in the same manner as in Example 1, except that 16 parts by weight of Compound (8) was used to prepare a coating solution for the underlayer instead of 0.01 parts by weight of 2,6-di-tert-butyl-4-methyl phenol.

### COMPARATIVE EXAMPLE 5

A laminated type photoreceptor drum was prepared in the same manner as in Example 1, except that 0.4 parts by weight of Compound (1) was used to prepare a coating solution for the charge transporting layer instead of 0.4 parts by weight of 2,6-di-tert-butyl-4-methyl phenol.

### COMPARATIVE EXAMPLE 6

A laminated type photoreceptor drum was prepared in the same manner as in Example 1, except that 0.4 parts by weight of Compound (8) was used to prepare a coating solution for the charge transporting layer instead of 0.4 parts by weight of 2,6-di-tert-butyl-4-methyl phenol.

### COMPARATIVE EXAMPLE 7

A laminated type photoreceptor drum was prepared in the same manner as in Example 1, except that 2,6-di-tert-butyl-4-methyl phenol was not used to prepare the coating solution for the underlayer, and 8.4 parts by weight of N,N′-bis(3-methyl phenyl)-N, N′-bis(phenyl)benzidine was used to prepare a coating solution for charge transporting layer instead of 4.2 parts by weight of 4-dibenzylamino-2-methylbenzaldehyde diphenylhydrazone and 4.2 parts by weight of 1,1-bis-(p-diethylaminophenyl)-4,4-diphenyl-1,3-butadiene.

Measurement of Image Density

The image densities of a black solid image pattern and a halftone image pattern obtained using each of the laminated type photoreceptors manufactured in the examples according to the present invention and the comparative examples were measured in a manner as follows.

The optical densities of a black solid image pattern having a square shape with a side length of 10 mm and a halftone image pattern having the same shape and size as the black solid image pattern, which were printed using a laser printer ML-1610 (manufactured by Samsung Electronics), in which a corresponding laminated type photoreceptor drum manufactured in Examples 1 through 23 and Comparative Examples 1 through 7 was installed, at 23° C. and a relative humidity of 50%, using an optical densitometer (“SpectroEye” manufactured by GretagMacbeth). The results are shown in Table 1. In Table 1, OD refers to an optical density as an index of the image density of a black solid image pattern, and HT OD refers to a halftone optical density as an index of the image density of a halftone image pattern. The image density after printing on a single sheet of paper and the image density after printing on 2000 sheets of paper were evaluated.

TABLE 1

| | |
|---|---|
| After printing on | After printing on |
| a single sheet | 2000 sheets |

| | OD | HT OD | OD | HT OD |
|---|---|---|---|---|
| Example 1 | 1.26 | 0.21 | 1.40 | 0.47 |
| Example 2 | 1.28 | 0.20 | 1.39 | 0.48 |
| Example 3 | 1.29 | 0.22 | 1.38 | 0.45 |
| Example 4 | 1.24 | 0.13 | 1.38 | 0.45 |
| Example 5 | 1.25 | 0.15 | 1.36 | 0.44 |
| Example 6 | 1.25 | 0.18 | 1.34 | 0.40 |
| Example 7 | 1.26 | 0.20 | 1.38 | 0.45 |
| Example 8 | 1.25 | 0.22 | 1.34 | 0.44 |
| Example 9 | 1.24 | 0.22 | 1.34 | 0.42 |
| Example 10 | 1.25 | 0.21 | 1.33 | 0.44 |
| Example 11 | 1.27 | 0.18 | 1.34 | 0.40 |
| Example 12 | 1.29 | 0.24 | 1.31 | 0.40 |
| Example 13 | 1.26 | 0.20 | 1.31 | 0.38 |
| Example 14 | 1.27 | 0.18 | 1.30 | 0.35 |
| Example 15 | 1.29 | 0.22 | 1.41 | 0.44 |
| Example 16 | 1.26 | 0.21 | 1.36 | 0.45 |
| Example 17 | 1.26 | 0.22 | 1.35 | 0.42 |
| Example 18 | 1.24 | 0.21 | 1.34 | 0.40 |
| Example 19 | 1.25 | 0.15 | 1.31 | 0.37 |
| Example 20 | 1.28 | 0.23 | 1.34 | 0.36 |
| Example 21 | 1.30 | 0.25 | 1.34 | 0.37 |
| Example 22 | 1.31 | 0.23 | 1.36 | 0.39 |
| Example 23 | 1.29 | 0.27 | 1.34 | 0.40 |
| Comparative | 1.26 | 0.22 | 1.44 | 0.55 |
| Example 1 | | | | |
| Comparative | 1.22 | 0.19 | 1.44 | 0.53 |
| Example 2 | | | | |
| Comparative | 1.23 | 0.18 | 1.40 | 0.48 |
| Example 3 | | | | |
| Comparative | 1.21 | 0.16 | 1.40 | 0.50 |
| Example 4 | | | | |
| Comparative | 1.25 | 0.25 | 1.48 | 0.56 |
| Example 5 | | | | |
| Comparative | 1.23 | 0.24 | 1.50 | 0.58 |
| Example 6 | | | | |
| Comparative | 1.30 | 0.22 | 1.36 | 0.45 |
| Example 7 | | | | |

Referring to Table 1, the optical densities of the images after printing on 2000 sheets were higher than after printing on a single sheet. This indicates that image deterioration occurs as the number of printing sheets increases, that is, as the photoreceptor is repeatedly used. However, when the photoreceptors manufactured in Examples 1 through 23 according to the present invention were used, variations in image density after printing on 2000 sheets were small both in the black solid image pattern and in the halftone image pattern. In other words, image deterioration (change in image density over time) is small when using the photoreceptors of the present invention, even after repeated use. However, in Comparative Examples 1 through 7 according to the prior art in which a phosphite-based heat stabilizer or thioether-based heat stabilizer was contained alone in the underlayer or in the charge transporting layer or a heat stabilizer was not contained in the underlayer, variations in image density in the black solid image pattern and in the halftone image patter after printing on 2000 sheets were greater than in Examples 1 through 23 according to the present invention. Accordingly, it is shown when the conventional photoreceptors of Comparative Examples 1 through 7 are used repeatedly, the image deterioration (change in image density over time) is great.

As described above, in a laminated type electrophotographic photoreceptor according to the present invention including an underlayer, a charge generating layer, and a charge transporting layer that are sequentially formed on an electrically conductive substrate, a predetermined combination of heat stabilizers is contained in the underlayer and the charge transporting layer, and a combination of a butadiene-based amine compound and a hydrazone-based compound, or a benzidine-based compound is used as a charge transporting material for the charge transporting layer. Thus, optical fatigue resistance and thermal fatigue resistance are improved, thereby suppressing image deterioration caused by repeated use. Accordingly, an electrophotographic image forming apparatus including the electrophotographic photoreceptor according to the present invention can stably provide a high quality image after repeated use.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An electrophotographic photoreceptor comprising:
an underlayer;
a charge generating layer; and
a charge transporting layer, wherein the layers are sequentially formed on an electrically conductive substrate,
wherein the underlayer includes a metal oxide, a binder resin, and a heat stabilizer;
the charge generating layer includes a binder resin and a phthalocyanine-based charge generating material; and
the charge transporting layer includes a charge transporting material, a binder resin, and a heat stabilizer.

2. The electrophotographic photoreceptor of claim 1, wherein the binder resin in the underlayer is at least one material selected from the group consisting of polyamide resin, phenol resin, melamine resin, and epoxy resin.

3. The electrophotographic photoreceptor of claim 1, wherein each of the underlayer and the charge transporting layer includes: 0.01-20% by weight of a phenol-based heat stabilizer based on the weight of the binder resin; 0.01-20% by weight of a mixture of a phenol-based heat stabilizer and a phosphite-based heat stabilizer in a weight ratio of 1:0.1-1:5 based on the weight of the binder resin; or 0.01-20% by weight of a mixture of a phenol-based heat stabilizer and a thioether-based heat stabilizer in a weight ratio of 1:0.1-1:5 based on the weight of the binder resin.

4. The electrophotographic photoreceptor of claim 1, wherein the heat stabilizer is selected from the group consisting of 2,6-di-tert-butyl-4-methyl phenol, n-octadecyl-3-(3′,5′-di-tert-butyl-4′-hydroxyphenyl)propionate, and tetrakis (methylene-3(3,5-di-tert-butyl-4-hydroxyphenyl)propionate.

5. The electrophotographic photoreceptor of claim 1, wherein the charge generating material is a metal-free phthalocyanine-based compound represented by Formula 1, a metal phthalocyanine-based compound represented by Formula 2, or a mixture thereof, 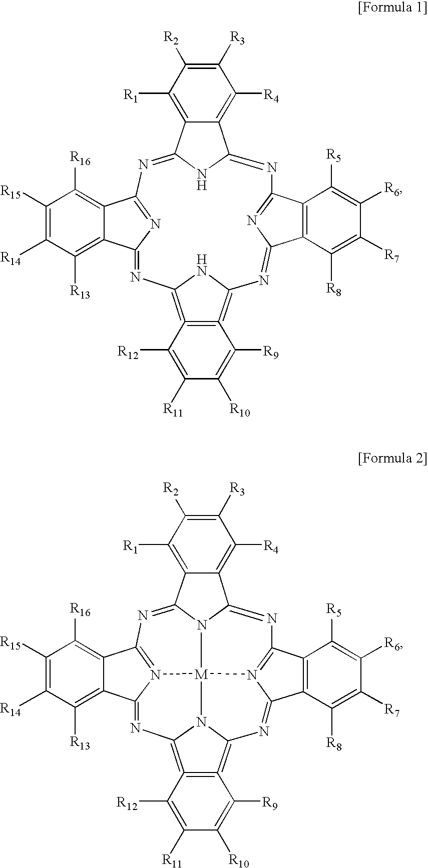
where R₁-R₁₆ are independently selected from the group consisting of a hydrogen atom, a halogen atom, a nitro group, an alkyl group, and an alkoxy group, and M is selected from the group consisting of copper, chloroaluminum, chloroindium, cholorogallium, cholorogermanium, oxyvanadyl, oxytitanyl, hydroxygermanium and hydroxygallium.

6. The electrophotographic photoreceptor of claim 1, wherein the binder resin in the charge generating layer is polyvinyl butylal, and the weight ratio of the charge generating material to the binder resin is in the range of 1:0.1-1:5.

7. The electrophotographic photoreceptor of claim 1, wherein the binder resin in the charge generating layer is polycarbonate-Z.

8. The electrophotographic photoreceptor of claim 1, wherein the charge transporting material is a combination of a butadiene-based amine compound and a hydrazone-based compound, or a benzidine-based compound.

9. An electrophotographic image forming apparatus comprising: an
electrophotographic photoreceptor; a charging apparatus for charging a photosensitive layer of the electrophotographic photoreceptor; an exposing apparatus for forming an electrostatic latent image on a surface of the photosensitive layer of the electrophotographic photoreceptor through exposure to laser light; and a developing apparatus for developing the electrostatic latent image,
wherein the electrophotographic photoreceptor comprises: an underlayer; a charge generating layer; and a charge transporting layer that are sequentially formed on an electrically conductive substrate,
wherein the underlayer includes a metal oxide, a binder resin, and a heat stabilizer, and the charge generating layer includes a binder resin and a phthalocyanine-based charge generating material, and the charge transporting layer includes a charge transporting material, a binder resin, and a heat stabilizer.

10. The electrophotographic image forming apparatus of claim 9, wherein the binder resin in the underlayer is at least one material selected from the group consisting of polyamide resin, phenol resin, melamine resin, and epoxy resin.

11. The electrophotographic image forming apparatus of claim 9, wherein each of the underlayer and the charge transporting layer includes: 0.01-20% by weight of a phenol-based heat stabilizer based on the weight of the binder resin; 0.01-20% by weight of a mixture of a phenol-based heat stabilizer and a phosphite-based heat stabilizer based on the weight of the binder resin in a weight ratio of 1:0.1-1:5; or 0.01-20% by weight of a mixture of a phenol-based heat stabilizer and a thioether-based heat stabilizer based on the weight of the binder resin in a weight ratio of 1:0.1-1:5.

12. The electrophotographic image forming apparatus of claim 11, wherein the heat stabilizer is selected from the group consisting of 2,6-di-tert-butyl-4-methyl phenol, n-octadecyl-3-(3′,5′-di-tert-butyl-4′-hydroxyphenyl)propionate, and tetrakis (methylene-3(3,5-di-tert-butyl-4-hydroxyphenyl)propionate.

13. The electrophotographic image forming apparatus of claim 9, wherein the charge generating material is a metal-free phthalocyanine-based compound represented by Formula 1, a metal phthalocyanine-based compound represented by Formula 2, or a mixture thereof, 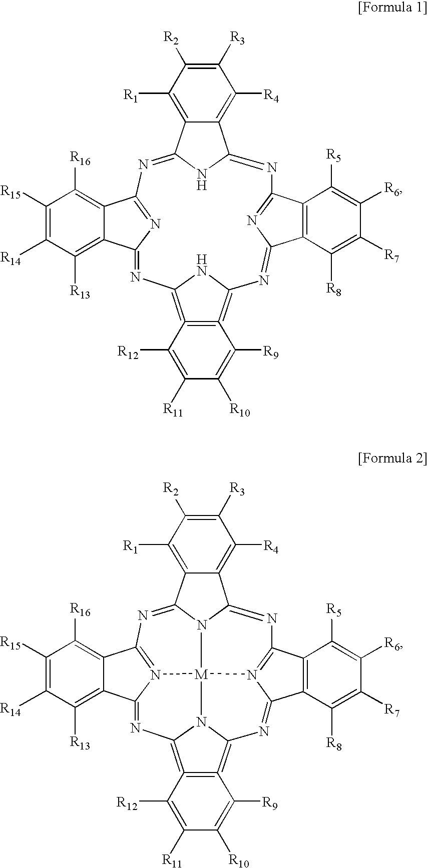
where R₁-R₁₆ are independently selected from the group consisting of a hydrogen atom, a halogen atom, a nitro group, an alkyl group, and an alkoxy group, and M is selected from the group consisting of copper, chloroaluminum, chloroindium, cholorogallium, cholorogermanium, oxyvanadyl, oxytitanyl, hydroxygermanium, and hydroxygallium.

14. The electrophotographic image forming apparatus of claim 9, wherein the resin in the charge generating layer is polyvinyl butylal, and the weight ratio of the generating material to the binder resin is in the range of 1:0.1-1:5.

15. The electrophotographic image forming apparatus of claim 9, wherein the resin in the charge generating layer is polycarbonate-Z.

16. The electrophotographic image forming apparatus of claim 9, wherein the transporting material is a combination of a butadiene-based amine compound and a one-based compound, or a benzidine-based compound.
